(19) United States
(12) Patent Application Publication
(10) Pub. No.: US 2018/0276697 A1
(43) Pub. Date: Sep. 27, 2018

(54) SYSTEM AND METHOD OF PROVIDING LOCATION-SPECIFIC GAMING ENTERTAINMENT WITH LOYALTY-BASED REWARDS

(71) Applicant: StoolDuel, Inc., Wilmington, NC (US)

(72) Inventor: Erik Charles Horbacz, Wilmington, NC (US)

(73) Assignee: StoolDuel, Inc., Wilmington, NC (US)

(21) Appl. No.: 15/933,342

(22) Filed: Mar. 22, 2018

Related U.S. Application Data
(60) Provisional application No. 62/474,694, filed on Mar. 22, 2017.

(51) Int. Cl. G06Q 30/02; G07F 17/32

(52) U.S. Cl. CPC G06Q 30/0209; G07F 17/3241; G07F 17/3255; G07F 17/3293; G07F 17/3279; G07F 17/323; G07F 17/3295; G07F 17/3239

(57) ABSTRACT

A method and system for providing location-specific games for redeeming location-specific rewards is provided. The method includes providing a system including an administrator platform, an establishment platform and a patron platform all in communication with each other. The administrator platform provides a game which can be customized by the establishment platform, which is associated with a geographic perimeter. The game can only be played within the perimeter. The system confirms the location of the patron platform within the perimeter, thereby permitting play or further customization of the game. Loyalty points specific to the perimeter can be earned when playing the game and are redeemable for location-specific rewards.

### CROSS REFERENCE TO RELATED APPLICATIONS

This application claims the benefit of U.S. Provisional Application No. 62/474,694 filed Mar. 22, 2017, which is herein incorporated by reference in its entirety.

### TECHNICAL FIELD

The present disclosure relates generally to systems and methods of providing location-specific gaming entertainment. Specifically, the present disclosure relates to systems and methods of providing location-specific gaming entertainment with location-specific loyalty-based rewards.

### BACKGROUND

Bar and restaurant establishments that sell alcohol are ubiquitous throughout societies, and for many visiting these establishments are a weekly occurrence. These patrons visit these establishments for food and libations, as well as intangibles such as socializing, relaxing, and entertainment.

It is an adage within the bar and restaurant industry, and in particular with respect to bars, that “the longer they stay, the more they pay”. Accordingly, it is typically in an establishment's best business interest to provide an environment wherein patrons will want to stay at an establishment for longer than is necessary to merely eat and have a drink.

Establishments employ various means to attract and retain patronage, including quality products and service, pool tables and arcade games, specials and discounts, and entertainment such as live music, dancing, comedy, karaoke, hosted trivia games, and so forth. More recently, establishments have incorporated video gaming systems such as bingo, poker and trivia, which allow patrons within an establishment to socialize and play games.

While known means to attract and retain patronage are somewhat effective, they effectiveness in creating customer loyalty between a given patron and a specific establishment is limited. Said another way, there is little incentive for a patron to return to a specific establishment to eat, drink and play video trivia because similar establishments likewise offers food, drinks and video trivia.

Therefore, what is needed is a system and method of providing location-specific gaming entertainment with loyalty-based rewards. It is desirable that a patron must visit a specific establishment to access the gaming system, and that a patron is incentivized to play games at a specific establishment. It is desirable that the games are customizable by the establishment with respect to game parameters and rewards. It is desirable that the games are easy to access by the patron, fun to play, facilitate social interactions between patrons at an establishment, and increase the time and money that a patron spends at an establishment. Disclosed herein are one or more devices and methods that advantageously address these issues.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a method and system for providing location-specific games for redeeming location-specific rewards is provided. The method includes providing a system including an administrator platform, an establishment platform and a patron platform all in communication with each other. The administrator platform provides a game which can be customized by the establishment platform, which is associated with a geographic perimeter. The game can only be played within the perimeter. The system confirms the location of the patron platform within the perimeter, thereby permitting play or further customization of the game. Loyalty points specific to the perimeter can be earned when playing the game and are redeemable for location-specific rewards.

According to at least another embodiment, the method and system further permit additional universal games to be played within any perimeter.

According to at least another embodiment, the method and system further permit invitations to be created from one patron platform for accepting specific other patron platforms to participate in a game within the perimeter established.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 schematically depicts three establishments each having a basic system according to at least one embodiment of the invention.

FIG. 2 schematically depicts three establishments each having a premium system with patrons playing both the universal game and public games according to at least one embodiment of the invention.

FIG. 3 schematically depicts three establishments each having a premium system with the patrons playing the universal game, public games, and private games according to at least one embodiment of the invention.

FIGS. 5-12 and 18-19 depict views of a patron platform according to at least one embodiment of the invention.

FIGS. 20-23 depict views of an establishment platform according to at least one embodiment of the invention.

FIGS. 24-25, 29, 31-32, 34-40 depict views of an administrator platform according to at least one embodiment of the invention.

FIG. 41 is a schematic drawing of the system for providing location-specific gaming entertainment with loyalty-based rewards according to at least one embodiment of the invention.

### DETAILED DESCRIPTIONS

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by e presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a system, or gaming system, 10. Furthermore, embodiments of the invention may take the form of a computer program product having a computer-readable storage medium having computer-executable program code embodied in the medium.

The system 10 may be implemented as a client/server architecture wherein a plurality of users 12 may communicate using their computing device 14 with a central hub 16 (e.g. server). The server may be a physical server or a virtual server. In other embodiments the server may be located on a company premise, or located in any other type of datacenter. The server may also be configured as a plurality of physical servers and/or virtual servers, In some embodiments, a server may provide the virtual server and may be implemented as a separated operating system (OS) running on one or more physical (i.e. hardware implemented) servers. Any applicable virtual server may by be used for the server function. The server may be implemented within a cloud computing data center environment or the like.

A computing device 14 may be a fixed device or a mobile device. For example, a fixed device may be an interactive kiosk, a personal computer, or the like. A mobile device may be any device capable of being transported easily from a one location to another location without undue difficulty and one that is capable of functional connection with a remote server. For example a mobile device may be a smart phone, a tablet, a personal digital assistant, a laptop, or the like. In general, a computing device as used with the system 10 may be any device providing a user input, display, and connectivity to one or more servers over a personal area network (PAN), a local area network (LAN) and/or a wide area network (WAN). The PAN may include Bluetooth® or Universal Serial Bus (USB). The LAN may include any combination of wired Ethernet and/or Wi-Fi access points. The WAN may include the Internet and/or another wide area private network. The WAN may also include any combination of 2G, 3G, 4G, and 5G networks. In some embodiments the WAN may include Data Over Cable Service Interface Specification (DOCSIS) networks and/or fiber networks such as passive optical networks (PONs). Access to the one or more servers may also be provided via a virtual private network (VPN) within any of the previously described networks.

The system 10 may communicate with the computing devices 14 via an app or through a website. In use, a user 12 first downloads the app or goes to the web location to register and log onto the system 10. In some embodiments, the user 12 registers by creating a unique ID and/or password that identifies the user 12 in the system 10. The system 10 may be combined with mobile technology, such that a patron 62, for example, may enter the system 10 with a mobile device 208 by simply going to a web location and/or opening an application 210.

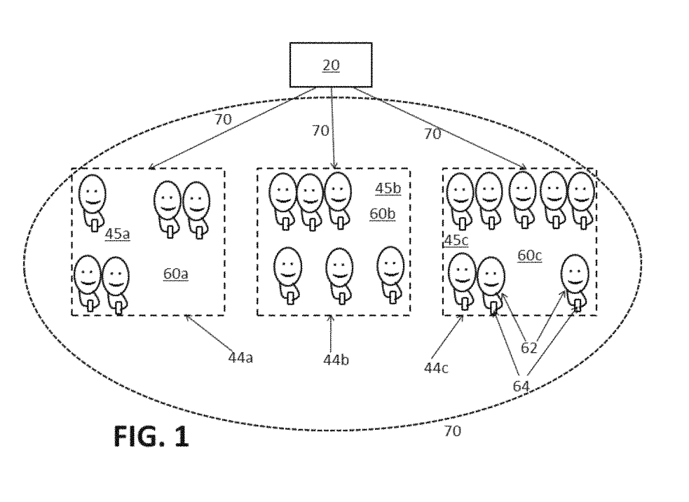

FIG. 1 depicts the system 10 in communication with a plurality of mobile devices 208, each hosting a mobile application 210 according to at least one embodiment of the system 10. Although FIG. 1 depicts the mobile devices 208 in communication with a single server 204 over a single network 212, a plurality of servers 204 and/or networks 212 may be used. The cloud based computing environment 206 may include one or more virtual servers 204 running server applications 202.

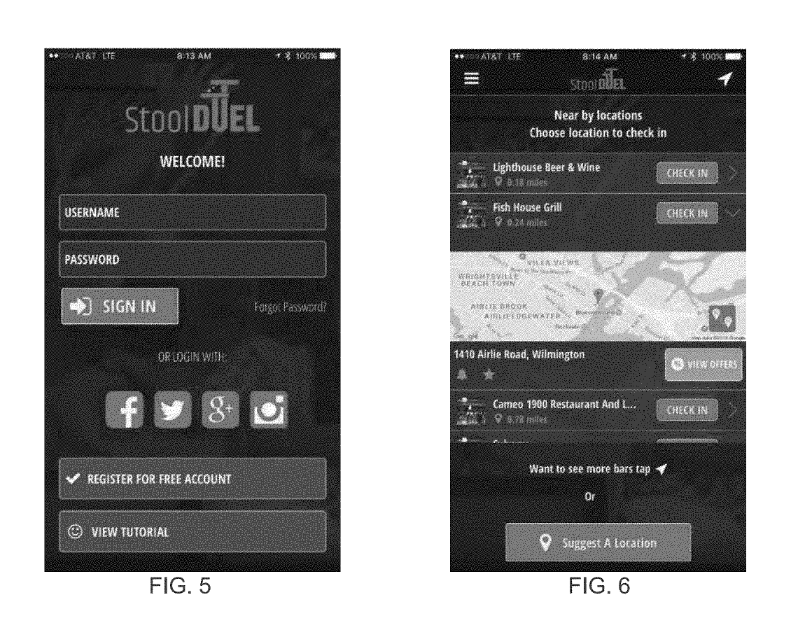

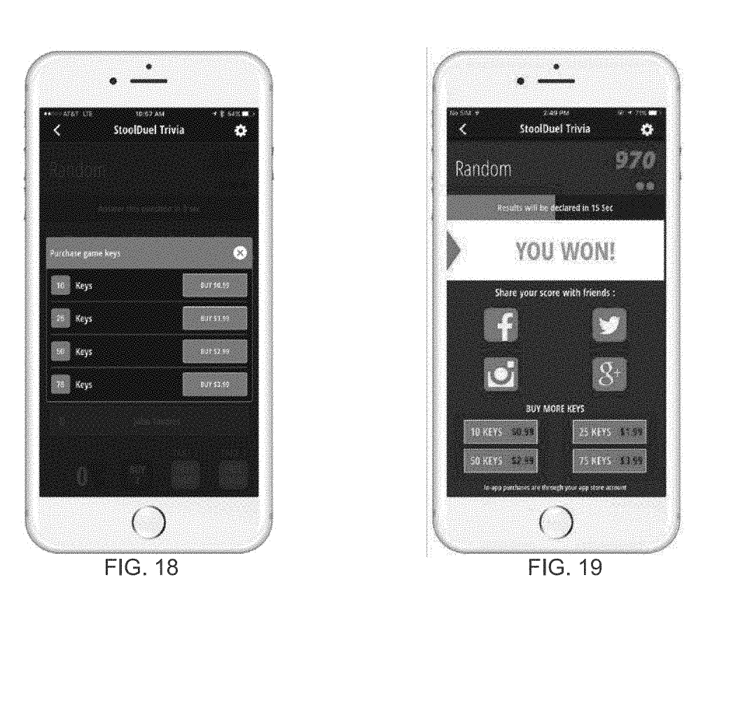

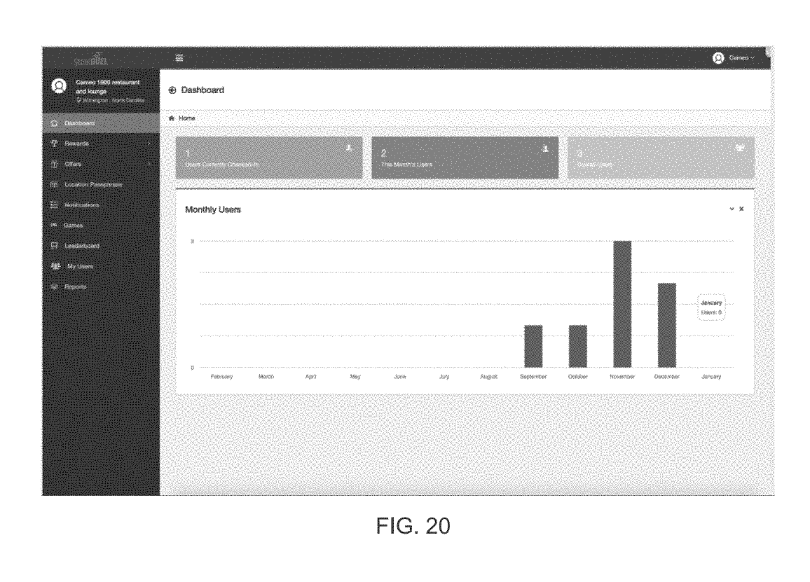

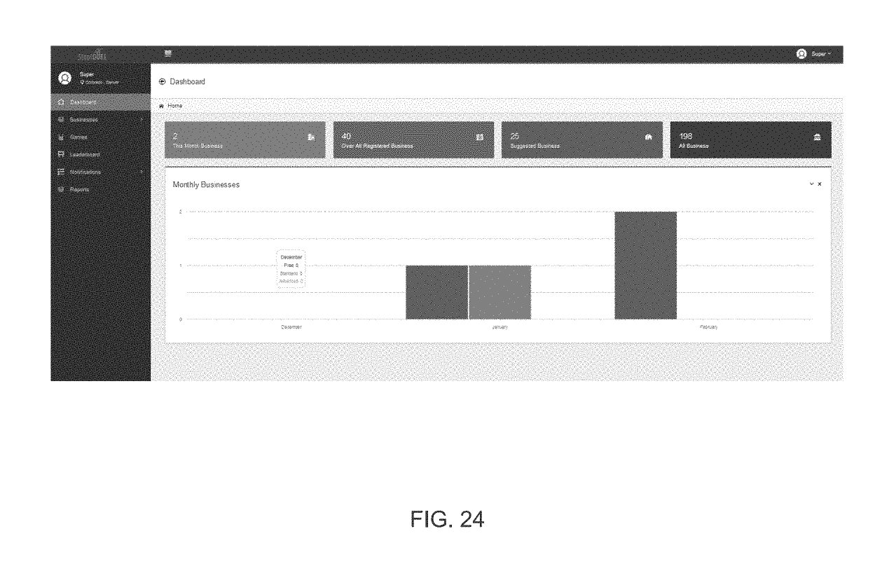

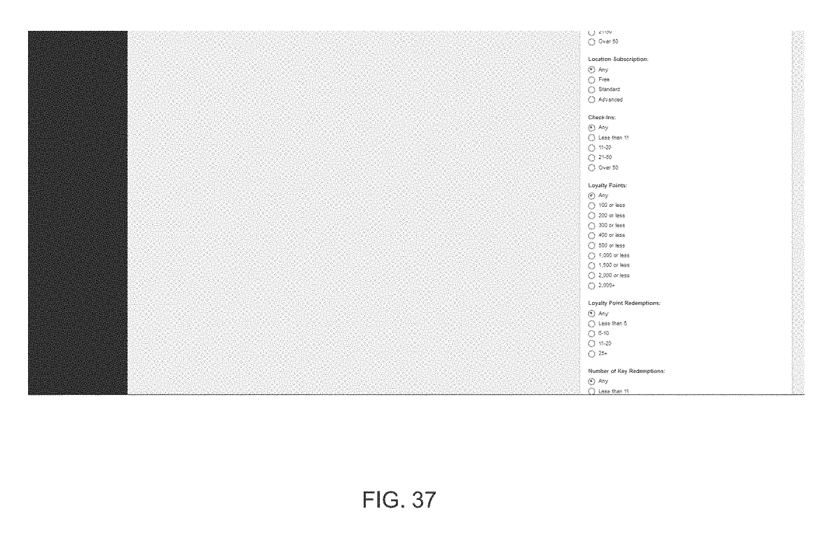

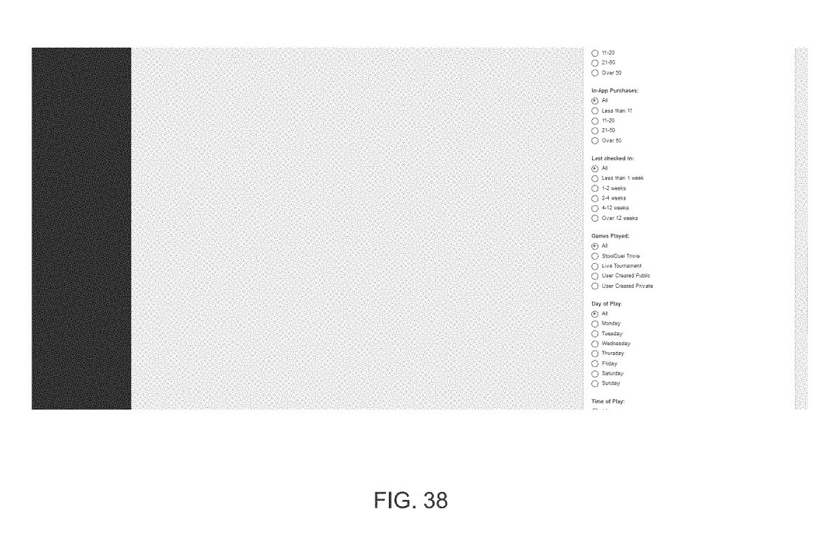

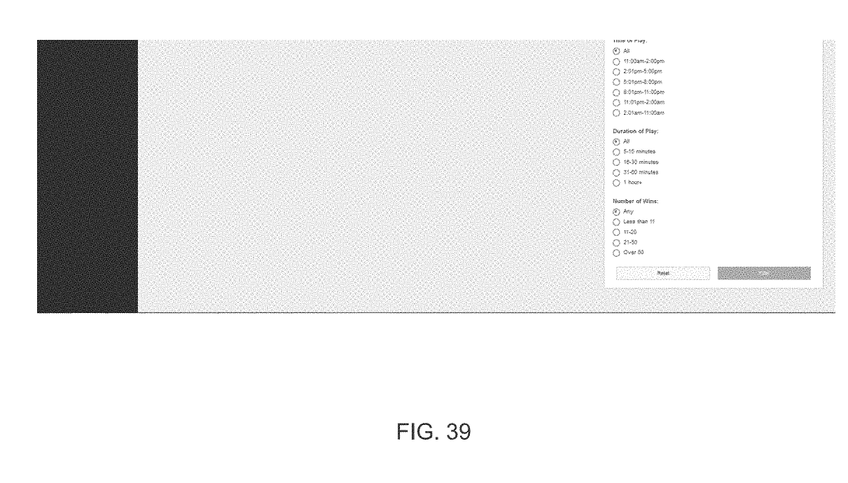

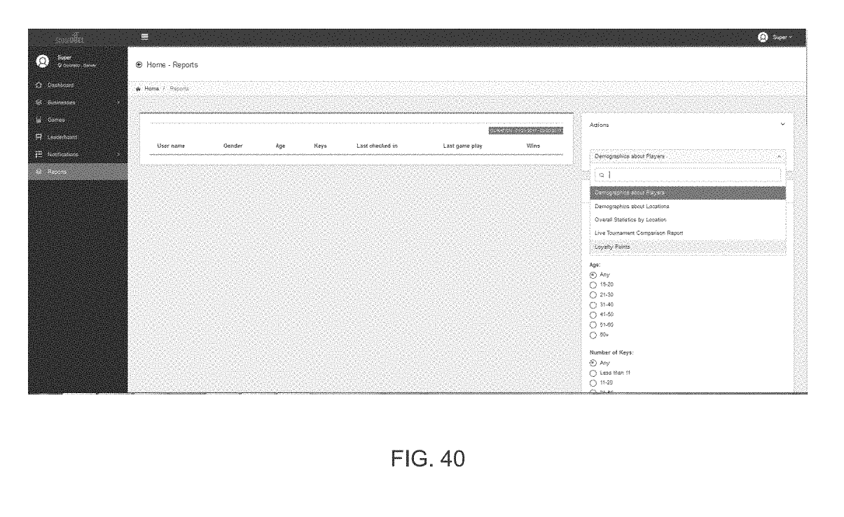

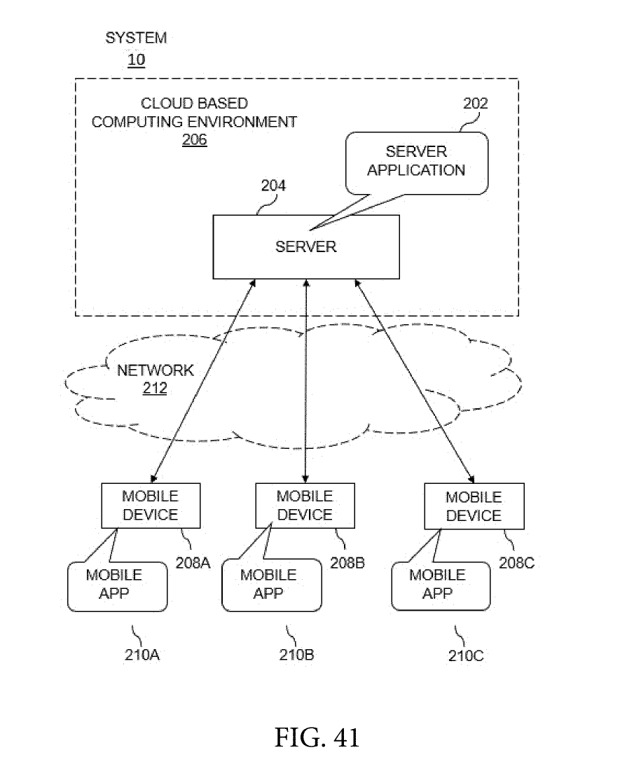

FIGS. 5-19 depict interfaces 100 of a computing device 14 being a mobile device 208 running a patron platform 60 of the system 10 according to some embodiments of the disclosed subject matter. FIGS. 20-23 depict interfaces 100 of a computing device 14 running an establishment platform 40 of the system 10 according to some embodiments of the disclosed subject matter. FIGS. 24-40 depict interfaces 100 of a computing device 14 running an administrator platform 20 of the system 10 according to some embodiments of the disclosed subject matter.

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

As used herein, an “app” is an application that is downloaded onto a mobile device.

As used herein, “entertainment” shall refer to computer-based competitive activities undertaken for pleasure, for example games of skill such as trivia and arcade style games; card games such as poker and blackjack; and games of chance such as slots and roulette.

As used herein, “establishment” shall refer to one or more specific sites, typically a bar or restaurant, which is defined by one or more physical perimeters. An establishment could be a location other than a bar or restaurant, such as a school, classroom, retail center, park, church, meeting center, residence, commercial establishment, and so forth. In some embodiments, an establishment may be a group of specific sites (e.g., chain of restaurants, or bars having the same owner(s)), each specific site having a defined physical perimeter.

As will be discussed in more detail herein, this disclosure describes and implies various embodiments of systems 10 and methods for providing location-specific gaming and/or loyalty-based rewards. The system 10 may include an administration platform 20, an establishment platform 40, and a patron platform 60. Users 12 of the system 10 may include one or more administrators 22 with access to the system 10 through at least the administrator platform 20, on or more managers 42 with access to the system 10 through at least one or more establishment platforms 40, and patrons 62 with access to the system 10 through at least one or more patron platforms 60. Any of the platforms 20, 40, 60 may accessed using any of the computing devices 14, servers 204, computing environments 206, and networks 212 described herein.

Administration platform 20 may be the highest hierarchal level of the system 10. Through the administration platform 20, an administrator 22 may create universal games 70, create settings for public and/or private games 71, 72, create or offer games/cheats/rewards, release updates to the system 10, access establishment and/or patron platform views, collect data and create analytics, collect and monitor live usage, and other typical software administrative functions, some of which are described herein.

The establishment platform 40 may be the middle hierarchal level of the system 10. Through the establishment platform 40, a manager 42 may customize certain settings 80, 82, 84 of games 70, 71, 72, cheats 90 and/or rewards 94, perform marketing and advertising functions, establish push notifications and related schedules and/or other functions described herein. In some embodiments of the system 10, a premier subscription to the system 10 may be purchased by a manager 42, thereby unlocking or permitting access to some or all of these functions. A basic subscription to the system 10 may be purchased by a manger 42, thereby unlocking or permitting access to some of these functions.

Patron platform 60 may be the lowest hierarchal level of the system 10. Through the patron platform 60, a patron 62 may check into an establishment 45, select and/or play a game 70, 71, 72, earn loyalty and/or game points 96, 98, redeem loyalty points 96 for rewards 94, and/or purchase and/or redeem keys 92 for cheats 90, amongst other functions described herein.

FIG. 1 schematically depicts three establishments 45a, 45b, 45c, having a basic subscription to the system 10. Establishments 45a, 45b, 45c may be defined by perimeters 44a, 44b, 44c respectively. In some embodiments, an establishment 45 may be defined by two or more perimeters 44, each perimeter defining a separate and distinct site location associated with, owned and/or controlled by the establishment 45, at least in part. Perimeters 44 may be established by GPS or RFID based geofencing technology. Any patron 62 may access the system 10 through a patron platform 60 using a computing device 14, and the patron 62 may associate the access to the system 10 with an establishment 45. The system 10 may display a pre-populated list, provide a searchable database and/or provide custom entry of establishments 45. Further, the system 10 may authenticate an establishment 45 associated with a patron's access using location data associated with the patron 62 and/or patron's computing device 14, and/or by verifying a received establishment password associated with the perimeter 44 and/or establishment 45. Additional use of establishment password authentication is particularly useful when perimeters 44 and/or establishments 45 have overlapping areas. Establishment passwords may take any number of forms available to one skilled in the art, including but not limited to alphanumeric entries, photo selections, answer selections, or verification scans.

Basic subscriptions to the system 10 may permit establishments 45 to provide one or more universal games 70 to patrons 60. A universal game 70 may be provided by the system 10 and have settings 80, 82, 84 adjustable through the administration platform 20. In some embodiments, the settings 80, 82, 84 are only adjustable through the administration platform 20. In other embodiments, the basic and enhanced settings 80, 84 are only adjustable through the administration platform 20, whereas graphic settings 82 may be adjustable through establishment platform(s) 40. At any given point in time, the basic and enhanced settings 80, 84 of a universal game 70 may be the same across all establishment platforms 40, so that every patron 62 accessing the universal game 70 may be presented with the same basic and enhanced settings 80, 84 (as indicated by the broken line oval in FIG. 1). In some embodiments, the patrons 62 and/or establishment platforms 40 may be presented with the same graphic settings 82 as well. In one example of a universal game 70, each patron 62 simultaneously participating in a universal game 70 would receive the same questions at the same time, with the same time period for answering, so that all patrons 62 simultaneously participating in the universal game 70 would effectively be playing against each other, regardless of the establishment 45 in which they were participating

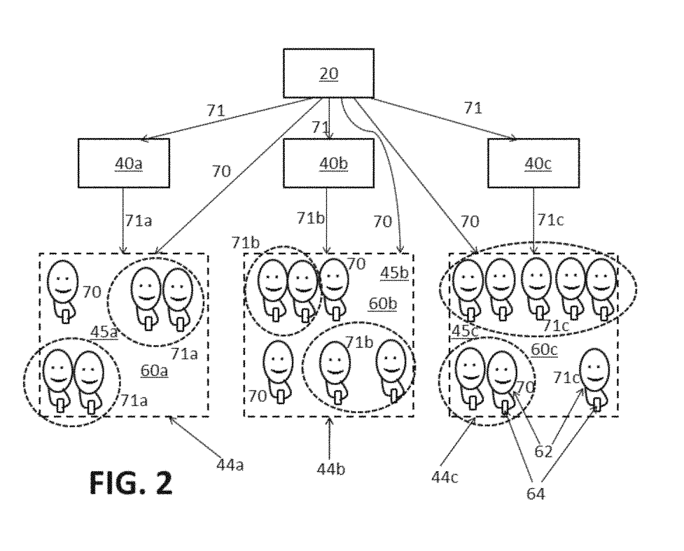

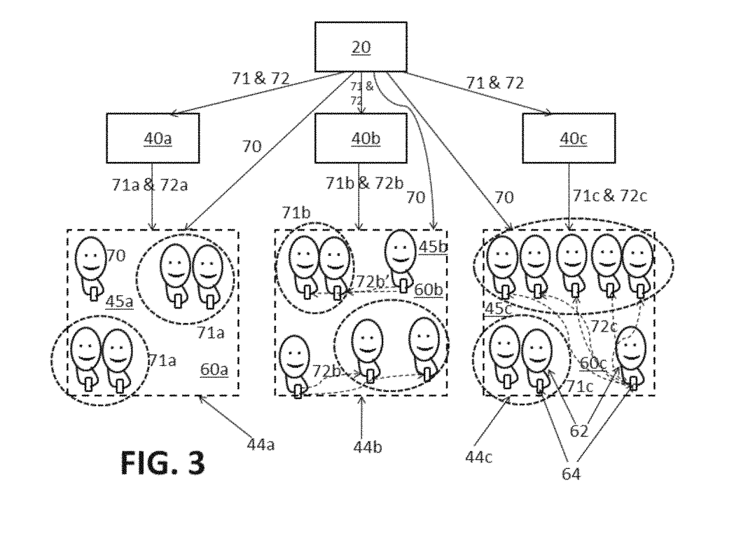

FIGS. 2 and 3 depict three establishments 45a, 45b, 45c having a premium subscription to the system 10. Premium subscriptions to the system 10 may permit establishments 45 to provide one or more public games 71 and/or private games 72 to patrons 60. Public and/or private games 71, 72 may be provided by the system 10 and have settings 80, 82, 84 adjustable through both the administrator platform 20 and the establishment platforms 40. In some embodiments, all the settings 80, 82, 84 of public and/or private games 71, 72 may be adjustable by any establishment platform 40 with a premium subscription. By having a premium subscription, each establishment 45 may create unique experiences for patrons 62 in comparison to other establishments 45, as well as create consistent, customized experiences amongst patrons 62 visiting the same establishment 45, All or some or one patrons 62 visiting the same establishment 45 may play a public game 71 at the same time.

In other words, a premium subscription to the system 10 by an establishment 45 may permit all patrons 62 checked into the establishment 45 through their patron platform 60 to participate in an establishment's customized public games 71 (FIG. 2, which also shows some patrons 62 participating in universal games 70). Further, a premium subscription to the system 10 by an establishment 45 may permit patrons 62 checked into the establishment 45 to participate in and/or create a private game 72. With respect to a private game 72, the establishment 45 may adjust and/or control some of the basic and/or enhanced setting 80, 84, while permitting a patron 62 creating a private game 72 to adjust and/or control other basic and/or enhanced settings 80, 84. A patron 62 creating a private game 72 may invite all patrons 62 of an establishment 45 to participate, only patrons 62 having specific qualities or settings (e.g., loyalty points totals, connected to creating-patron on a social media or other platform), or specific patrons 62, whether custom-entered or selected from a pre-populated list. Premium subscriptions to the system 10 may also allow for universal games to be accessed by patrons 62 at the establishment 45.

Referring to FIG. 2, some patrons 62 are playing universal game 70 provided by the administration platform 20, while other patrons 62 are playing public games 71 that originate from administration platform 20 but are customized by establishment platforms 40a, 40b, 40c. Broken line ovals indicate which patrons 62 are playing which games 70, 71. Patrons 62 of establishment 45a are playing public game 71a, patrons 62 of establishment 45b are playing public game 71b, and patrons 62 of establishment 45c are playing public game 71c, but all patrons 62 playing universal game 70 are playing the same game.

FIG. 3 depicts establishments 45a, 45b, 45c with a premium subscription and offering public game(s) 71 and private game(s) 72. Private game 72 may originate from administration platform 20 and may be customized by establishment platforms 40a, 40b, 40c and/or creating-patrons 62. Patron 62 wishing to create (or initiate, if settings are not customized/customizable by patron 62) a private game 72 can invite other patrons 62 within the same establishment 65. In establishment 45a, a single patron 62 is playing universal game 70, and two pairs of patrons 62 are playing public game 71a. In establishment 45b, a single patron 62 has initiated private game 72b with two patrons 62, and another single patron 62 has created private game 72b with two other patrons 62, In establishment 45c, a single patron 62 has created private game 72c with five patrons 62, and one pair of patrons 62 is playing public game 71c.

FIG. 5 is a screenshot of at least one embodiment of the patron platform 60 depicting a sign-in and registration interface. A patron 62 may register for a new account and/or access their existing account using their preselected username and password or an associated social media account. A patron 62 may also access a tutorial for the gaming system 10.

FIG. 6 is a screenshot of at least one embodiment of the patron platform 60 depicting a check-in for a patron 62. The patron 62 may use this page to locate nearby participating establishments 45. Further, the system 10 may provide to the patron platform 60 a map of participating establishments 45 located nearby, a patron platform 60 favoriting feature to save establishments 45, an alarm feature to remind the patron 62 to visit an establishment 45 at a later time, and/or the ability to view offers and/or rewards and/or games provided by the establishment 45 and/or its patrons 62. Further, the data in the preceding sentence may be accessible by a patron 62 upon checking-in to an establishment 45. Once a patron 62 is positioned within the perimeter(s) 44 associated with an establishment 45, the patron 62 may check-in to that establishment 45 using the check-in feature on the platform 60, thereby gaining access to games 70, 71, 72 offered and/or customized by that establishment 45 and/or checked-in patrons 62.

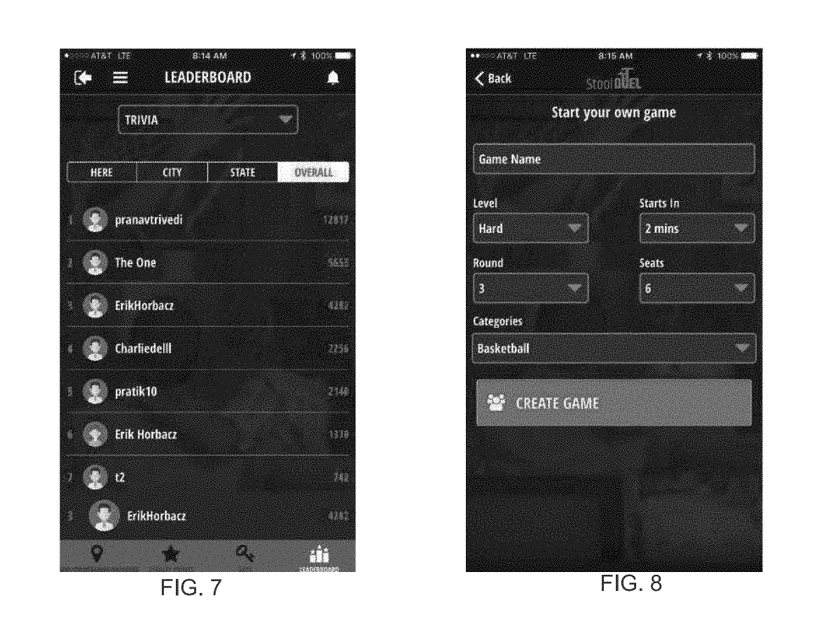

FIG. 7 is a screenshot of at least one embodiment of the patron platform 60 depicting a leaderboard of a universal game 70. In other embodiments, leaderboards may be provided by the system 10 in association with public and/or private games 71, 72. A patron 62 may select from different tabs to view a leaderboard read-out for particular areas, such as establishment 45, city, state or overall. The leaderboard may be populated and/or ranked according to game points 98, loyalty points 96, or some other metric associated with patrons 62. In some embodiments, establishment leaderboards may be created and/or displayed for displaying totals, averages and/or highest values from patrons 62 of the establishment 45 in comparison to patrons 62 of other establishments. In yet another embodiment, a leaderboard may be created and/or displayed for displaying totals, averages and/or highest values from patrons 62 of different and distinct perimeters 44 of the same establishment 45. In each embodiment, the leaderboard read-out may be associated with a particular game, all games of a particular type—universal, public or private, or with all games 70, 71, 72.

FIG. 8 is a screenshot of at least one embodiment of the patron platform 60 depicting a page for a patron 62 to create a private game 72. The settings depicted in FIG. 8 that are modifiable by the patron 62 include the name of the game, difficulty level, starting time, number of rounds, number of seats (or number of patron permitted to play), and categories from which questions or other settings may be pre-populated. For example, by selecting “basketball” in a trivia game, only basketball-related questions would be provided during game play by the system 10, the system 10 drawing the questions from a pre-populated list provided and/or modified through the administrator platform 20, establishment platform 40, and/or patron platform 60.

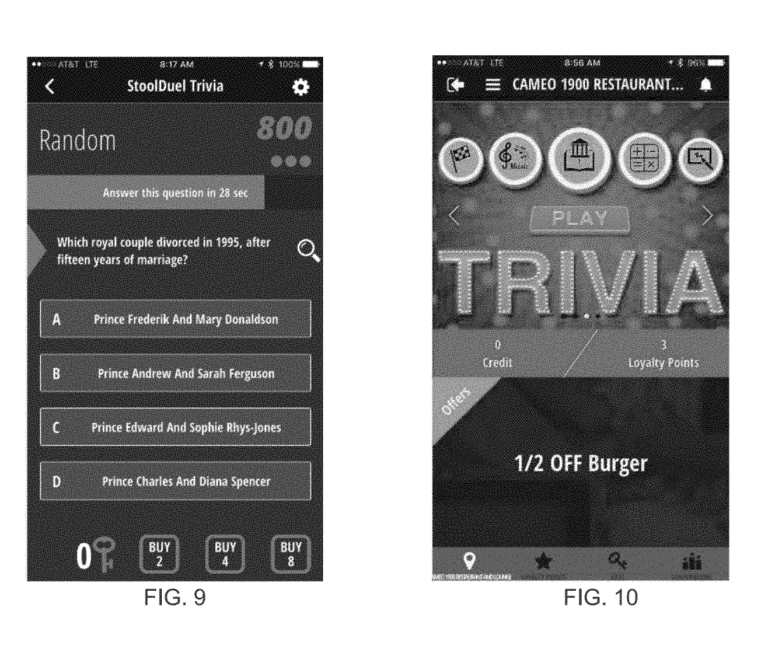

FIGS. 9 and 10 are screenshots of at least one embodiment of the patron platform 60 depicting a universal game 70 being a trivia game. FIG. 10 depicts an embodiment of a start page for the trivia game, whereas FIG. 9 depicts the trivia game in progress. Patrons 62 may view the questions and select from displayed answer choices to progress through the trivia game. The time remaining for patrons 62 to answer each particular question may be provided and/or displayed while the game is in progress (similarly, available time and/or starting time may be displayed in other games 70, 71, 72).

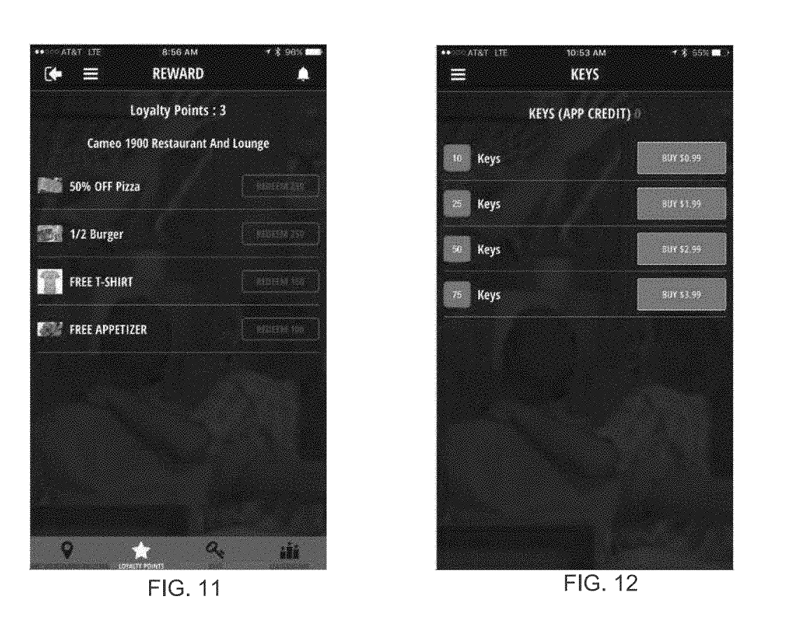

FIG. 11 is a screenshot of at least one embodiment of the patron platform 60 depicting rewards 94 available for redemptions for a patron 62 of a participating establishment 45. Rewards 94 may be establishment-specific and/or perimeter-specific, where each establishment 45 may create and/or select rewards 94 available to offer to patrons. Patrons may earn loyalty points 96 specific to each establishment 45 and/or perimeter 44 by participating in the system 10 and/or games 70, 71, 72 when checked-in at the establishment 45 and/or perimeter. Earning loyalty points 96 may rely on time spent on the system 10 and/or games 70, 71, 72 and/or may correlate to winning games 70, 71, 72 and/or scoring game points 98. Patrons 62 may view their balance of loyalty points 96 for each establishment 45 and/or perimeter 44 through the patron platform 60, as provided by the system 10. Loyalty points 96 may be redeemed for qualified rewards 94.

12 is a screenshot of at least one embodiment of the patron platform 60 for purchasing keys or credits 92. Keys 92, as depicted by the key symbol in other figures, permit a patron to purchase cheats 90, which may be used in any game 70, 71, 72. Cheats 90 may be universal or may be custom created by an establishment 45 for use in a customized public and/or private game 71, 72 and/or by a patron 62 for use in a customized private game 72. The customized cheats 90 are only redeemable in the establishment 45 by which is was created and/or by the participants in the public or private game 71, 72 created or initiated. In at least one embodiment, a cheat 90 may be in the form of a hint for answering a question, more time to answer a question, free ‘miss’ or ‘wrong answer’ pass for a game, amongst other possibilities to aid a patron 62 during game play. For example, with 15 seconds remaining the patron 62 may eliminate a wrong answer without penalty through use of a cheat 90.

FIG. 13 is a screenshot of a trivia game in progress on a patron platform 60 and displaying the in-game option to purchase cheats 90. When a patron 62 selects the on-screen option to buy cheats 909 while a game is in progress, as shown at the bottom of FIG. 9, a pop up screen may open for the patron 62 to make an immediate purchase without exiting the game 70, 71, 72.

FIG. 19 is a screenshot of an end of game message screen on a patron platform 60. A patron 62 may view their game results and game points 98 on this screen. The patron 62 may choose to share their points 98 on social media. The patron 62 may also purchase game cheats 90 for their account. Game points 98 may be awarded according to the settings of each game 70, 71, 72, which may be customized through the administrator platform 20, establishment platform 40 and/or patron platform 60. In some embodiments, the administrator platform 20 may award game points 98 according the establishment 45 and/or perimeter 44 associated with the patron 62 playing the game 70, 71, 72. Such location-specific awarding of game points 98 may encourage participation at particular establishments 45 and/or perimeters 44 by patrons 62.

As is depicted in FIG. 10, offers, specials or other advertisements associated with the participating establishment 45 and/or perimeter 44 may be provided and/or displayed on a patron platform 60. Loyalty points 96 accrued by a patron 62 for the participating establishment may be calculated, provided and/or displayed. Advertisements and/or push notifications may be created and/or scheduled by the administrator and/or establishment platforms 20, 40 and pushed to the establishment and/or patron platforms 40, 60. The advertisements and/or push notifications may be automated or one-time manual deliveries offering prizes, rewards 94, keys 92, points 96, photos, texts or any other data available.

In some embodiments, the system 10 interfaces with credit card companies or processors or other systems to allow transactions and/or redemptions to be completed. In other embodiments, payments may be transferred or communicated to point-of-sale systems. In some embodiments, transactions made by the patron 62 directly with the establishment point-of-sale system and may be captured by the establishment platform and used to provide loyalty points, keys and/or game points.

Basic and/or enhanced settings 80, 84 may include but are not limited to available time to answer, cheats enabled, questions presented, questions available to present, time at which game starts, difficulty level, number of rounds, name of game, number of seats (or number of patron permitted to play), categories from which questions or other settings may be pre-populated, rewards and cheats available, and/or point dispersement rate.

As depicted in FIGS. 20-23, the system 10 may provide data and analytics to a dashboard 86 viewable through the establishment platform(s) 40 and/or administrator platform(s) 20. Each dashboard 86 viewable through the establishment platform 40 may display data and analytics specific to the establishment 45 associated with the platform 40 and/or any perimeter 44 associated with the establishment 45. Alternatively, when viewed through an administrator platform 20, an establishment 45 and/or perimeter 44 may be selected.

FIG. 20 is a screenshot of the dashboard 86 according to at least one embodiment displaying usage of the system 10 within an establishment 45 and/or perimeter 44 by patrons 62 over time. Specific patron 62 usage over time may also be displayed. The system 10 may be integrated with, or communication with, establishment/perimeter point-of-sale systems or other management systems to display usage percentage amongst all visitors to an establishment and/or perimeters 44.

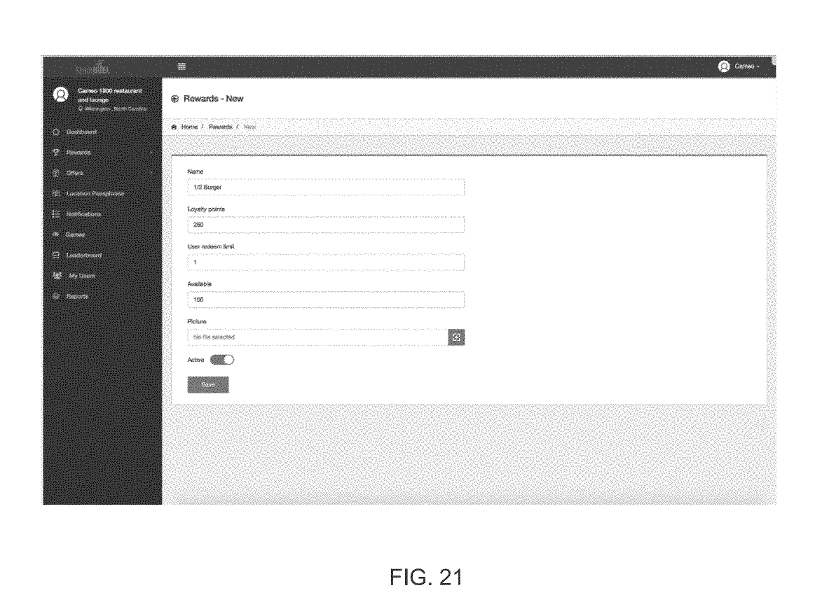

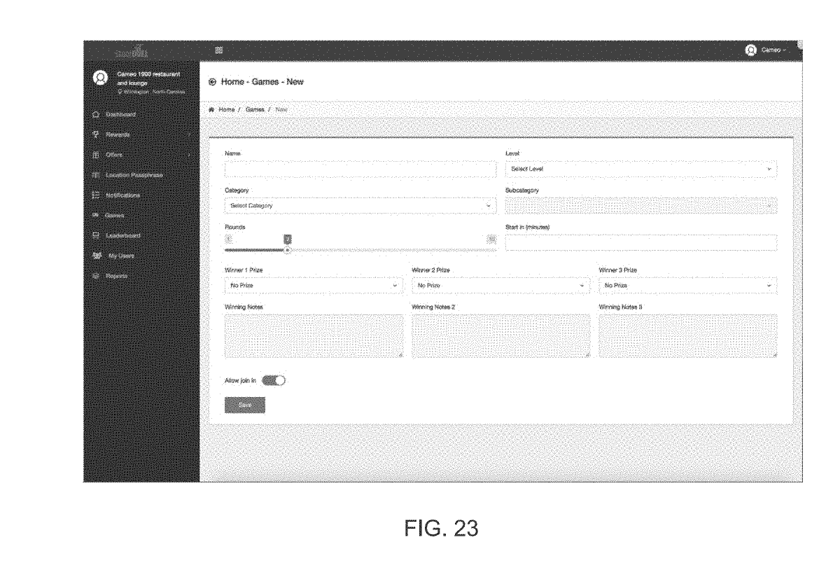

FIG. 21 is a screenshot of the dashboard 86 according to at least one embodiment displaying a page for adding new rewards 94. The rewards 94 may be activated or deactivated. The dashboard 86 may display a similar page for adding new games, customizing games, creating or customizing cheats, creating new advertisements, and/or creating push notifications. FIG. 23 is a screenshot of the dashboard 86 displaying a page for adding new games.

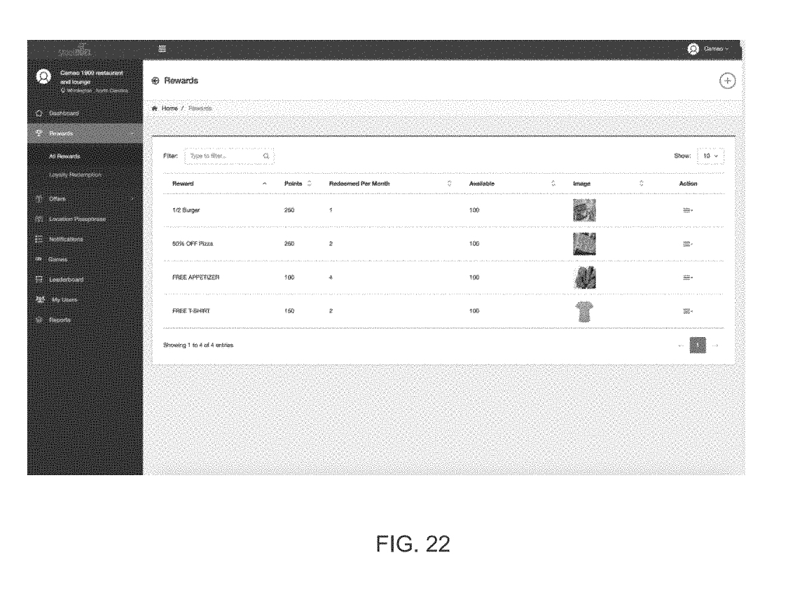

FIG. 22 is a screenshot of the dashboard 86 according to at least one embodiment displaying all the current rewards 94 provided by an establishment 45 and/or perimeter 44, as well as the reward usage and reward settings. The dashboard 86 may display a similar page for games, cheats, advertisements, and/or push notifications.

As depicted in FIGS. 24-40, the system 10 may provide data and analytics to a control panel 87 viewable through the administrator platform(s) 20. An administrator 22 may create new games, settings, cheats, rewards and other system properties through the administrator platform 20 access to the control panel 87.

FIG. 24 is a screenshot of the control panel 87 according to at least one embodiment for displaying usage of the system 10 by establishments 45, perimeters 44 and/or specific groups of establishments 45 and/or perimeters 44 over time. The usage may be apportioned according to whether a basic subscription or premium subscription is held.

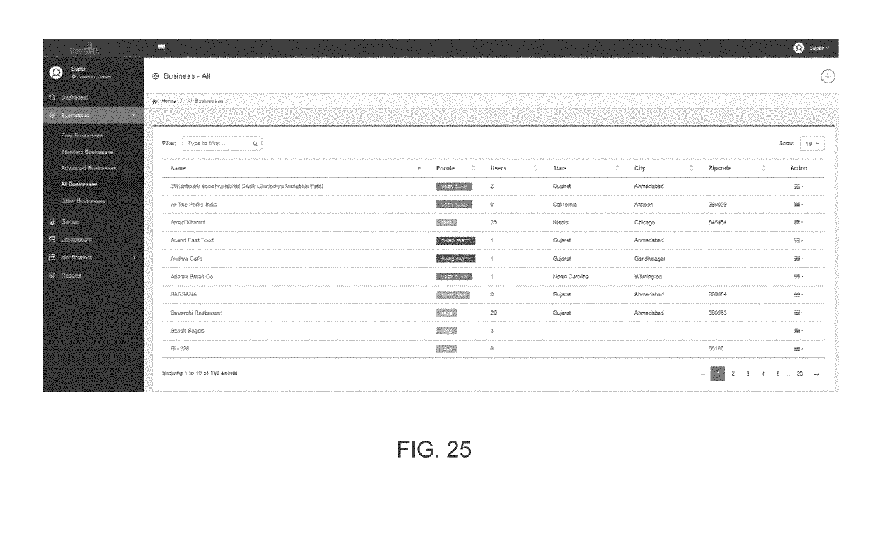

FIG. 25 is a screenshot of the control panel 87 according to at least one embodiment for displaying a list of establishments 45, perimeters 44 and/or specific groups of establishments 45 and/or perimeters 44, and the settings, properties, bibliographic information, usage and/or subscription information associated therewith. The system 10 may permit an administrator to select an establishment 45 and/or perimeter 44 for logging in and viewing data and analytics through the establishment and/or perimeter's establishment platform 40, as well as creating customizations and/or altering settings as the establishment 45 and/or perimeter 44.

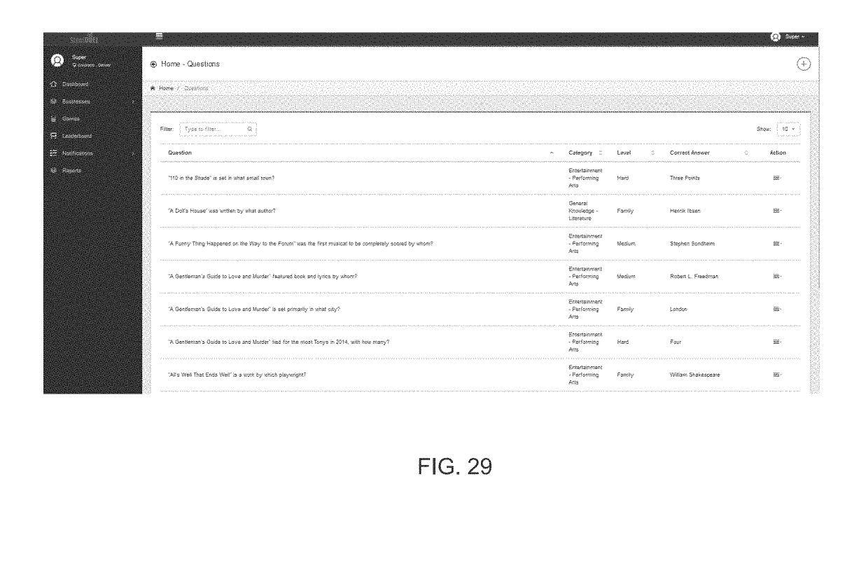

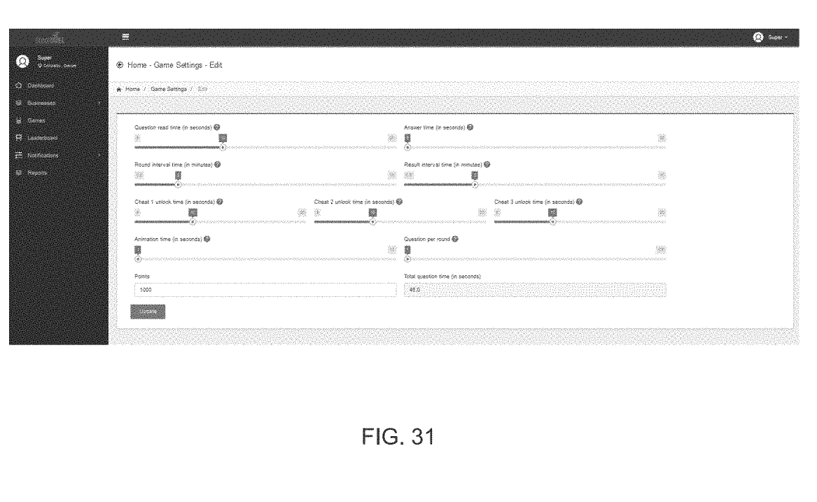

FIG. 29 is a screenshot of the control panel 87 according to at least one embodiment displaying a list of questions and the associated properties with the questions. Questions may be added, edited and/or deleted. A similar page may be provided through the establishment platform 40 for mangers 42 of establishments 45 and/or perimeters 44 to add/edit/delete, and/or through the patron platform 62 for patrons to add/edit/delete. Categories of questions may be added, edited and/or deleted in a similar manner.

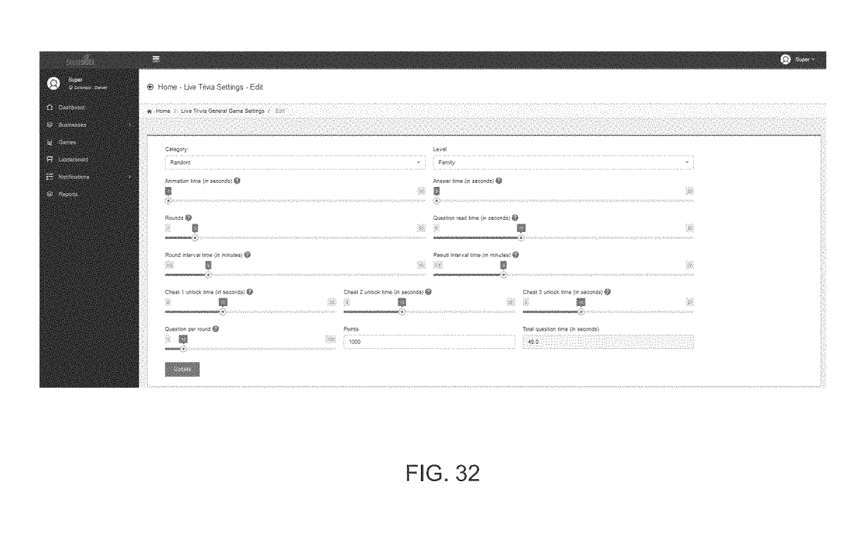

FIGS. 31 and 32 are screenshots of the control panel 87 according to at least one embodiment for displaying settings 80, 84 of a game 70, 71, 72 for editing. A similar page may be provided through the establishment and/or patron platform 40, 60 for creating custom games.

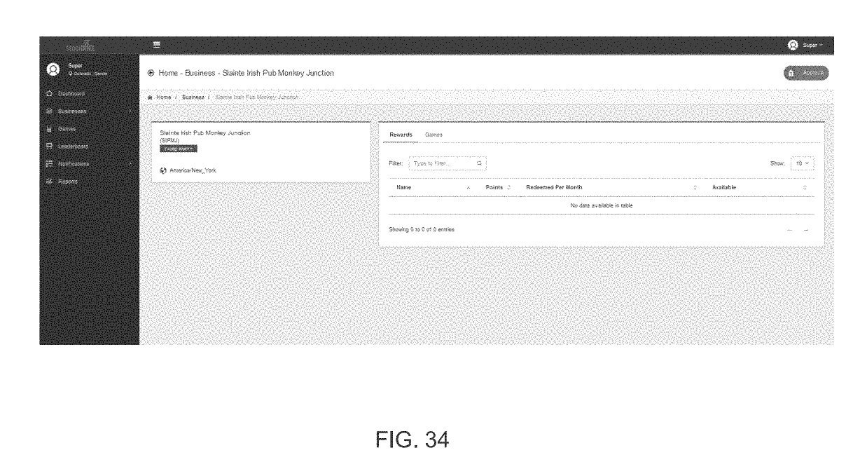

FIG. 34 is a screenshot of the control panel 87 according to at least one embodiment displaying an account page associated with an establishment 45 and/or perimeter 44. An administrator 22 may view which games 70, 71, 72, rewards 94 and/or cheats 90 are being offered, how many points 96 are required to redeem each reward 94, how keys 92 are required to redeem each cheat 90, and/or a list of how many rewards 94 are redeemed each month and how many rewards 94 remain available.

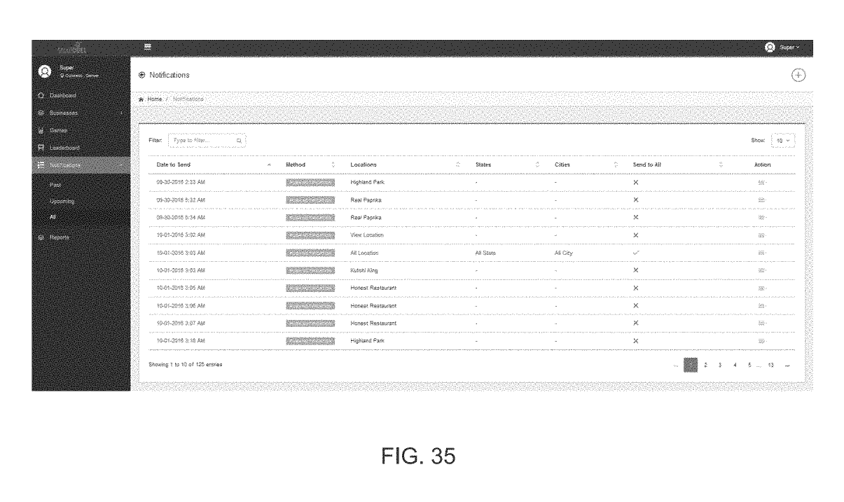

FIG. 35 is a screenshot of the control panel 87 according to at least one embodiment displaying all past and upcoming notifications by date and time, and establishment 45 and/or perimeter 44.

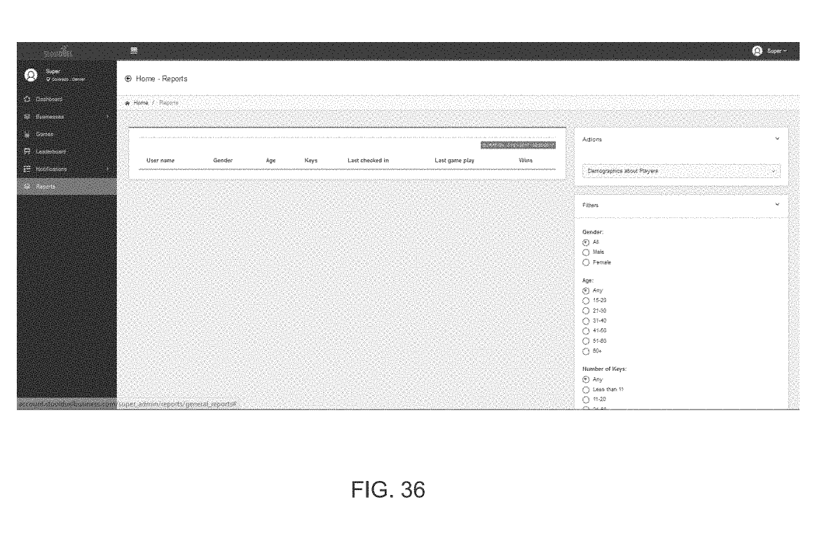

FIGS. 36-40 are screenshots of the control panel 87 according to at least one embodiment having an interface for creating reports. Reports may be generated using any number of factors, including but not limited to various patron 62, establishment 45, perimeter 44 and/or geographic demographics, loyalty points 96, game comparisons, and overall statistics.

The system 10 may be configured for retrieving and storing data transferred amongst various administrator, establishment and patron platforms 20, 40, 60, as well as effecting transactions and communications therebetween. As described herein, at least one server, memory and/or processor may be used by the system 10, each or any configured for operating to perform the functions described herein.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. Rather, modifications may be made without departing from the spirit and scope of the invention as set forth in the following claims. Examples of modifications include a social communication feature for communicating with others and playing against friends, user profiles with game statistics and favorite locations, city wide tournaments, and league play. Another feature is a tiered reward system with limited prizes and parameters displayed for patrons. For example, the first player at specific establishment to earn 10,000 loyalty points gets a $100 gift card, or the like. It should be understood that all specifications, unless otherwise stated or contrary to common sense, are +/−10%, and that ranges of values set forth inherently include those values, as well as all increments between.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The invention claimed is:

1. A method of providing location-specific games for redeeming location-specific rewards comprising:
providing a system including an administrator platform, an establishment platform and a patron platform all in communication with each other;
the administrator platform providing a game;
the establishment platform associated with a geographic perimeter customizing the game for use only within the perimeter;
the administration platform confirming a position of the patron platform is within the perimeter; and
the patron platform participating in the game for earning loyalty points, the loyalty points redeemable with the establishment platform when the patron platform is within the perimeter;
the patron platform redeeming the loyalty points for a reward, the reward available within the perimeter.

2. The method of claim 1, further comprising:
the administrator platform providing a second game;
the establishment platform customizing the second game;
a second patron platform further customizing the second game;
the second patron platform inviting at least another patron platform to participate in the second game;
the another patron platform participating in the second game.

3. The method of claim 1, further comprising:
a second establishment platform associated with a second perimeter customizing the game for use only within the second perimeter;
the administration platform confirming a position of the patron platform is within the second perimeter; and
the patron platform participating in the game for earning second loyalty points, the second loyalty points redeemable with the second establishment platform when the patron platform is within the second perimeter;
the patron platform redeeming the second loyalty points for a second reward, the second reward available within the second perimeter.
